(19) United States
(12) Patent Application Publication
(10) Pub. No.: US 2015/0159979 A1
(43) Pub. Date: Jun. 11, 2015

(54) ACCORDION FOLDERS UTILIZING BALLISTIC MATERIALS FOR IMPROVED BULLET RESISTANCE

(71) Applicant: Daren Berringer, Collegeville, PA (US)

(72) Inventor: Daren Berringer, Collegeville, PA (US)

(21) Appl. No.: 14/562,320

(22) Filed: Dec. 5, 2014

Related U.S. Application Data
(60) Provisional application No. 61/912,910, filed on Dec. 6, 2013.

(51) Int. Cl. F41H 5/08; B65D 25/28; B42F 7/08; B65D 25/04

(52) U.S. Cl. CPC F41H 5/08; B65D 25/04; B65D 25/282; B42F 7/08

(57) ABSTRACT

A folder suitable for holding and organizing paper and school materials further comprising ballistic materials disposed of in a front cover and back cover of said folder.

### FIELD OF THE INVENTION

This application claims priority to U.S. provisional patent application No. 61/912,910 filed on Dec. 6, 2013, which is incorporated herein by reference.

Presently disclosed embodiments are related to filing folders or carriers, especially those utilized by school age children wherein said filing folders comprise ballistic materials that provide improved bullet and shrapnel resistance.

### BACKGROUND

Numerous serious attacks on school age children reveal the need for simple, yet, effective devices to aid in protecting such children from deadly assault. While mechanisms exist to prevent intrusion of armed individuals into school zones, these attempts have, to date, proven unsuccessful in most instances. Indeed, it is likely impossible to prevent entrance into some of these school zones where entry is by force.

Accordingly, while debate rages on about the ability of school officials or teachers to carry concealed weapons, as well as other strategies to minimize risk to children, there has yet to be simple, yet effective products that children can utilize to protect themselves should they face an attack by a gun or other explosive that may produce shrapnel.

A variety of organizer systems and organizer devices are known in the art and are provided with various pockets for storing materials, useful tools, paper, and the like. For example, U.S. Pat. No. 3,904,003 to Margerum, issued Sep. 9, 1975, discloses a combination carrying case and traveling desk having a handle and an accordion file with pockets for storing various items. Another example is the portable file case disclosed in U.S. Pat. No. 4,936,454 to Wang, issued Jun. 26, 1990, which allows for the stored files, having a plurality of compartments to be removed from case. Yet another example is the combination organizer and accordion file disclosed in U.S. Pat. No. 5,954,170 to Chisolm, issued Sep. 21, 1999, that is provided with carrying handles and which has built in pockets and storage areas as well as an accordion file with dividers.

Further organizer type products exist, comprising numerous features, including: U.S. Pat. No. 7,055,682, issued to Domotor et al. on Jun. 6, 2006, discloses a padfolio with compartmentalized interior, U.S. Pat. No. 6,578,706, issued to Thompson on Jun. 17, 2003, discloses a folding portfolio organizer, U.S. Pat. No. 5,020,673, issued to Adams on Jun. 4, 1991, discloses a carrying case for personal items, U.S. Pat. No. 5,984,092, issued to Heard-Willmon on Nov. 16, 1999, discloses a folding organizer, U.S. Pat. No. 7,909,234, issued to Maistrellis on Mar. 22, 2011, discloses a compact storage device for receipts, coupons, and other small paper documents, U.S. Pat. No. 6,837,368, issued to Chang on Jan. 4, 2005, discloses compact disc container, U.S. Pat. No. 5,947,279, issued to Lee et al. on Sep. 7, 1999, discloses a storage system, U.S. Pat. No. 5,630,509, issued to Su on May 20, 1997, discloses an accordion-like file, U.S. Pat. No. 5,664,724 issued to Ho on Sep. 9, 1997, discloses a compartmentalized file folder apparatus, U.S. Pat. No. 6,607,122, issued to Ong on Aug. 19, 2003, discloses combined detachable filing wallet devices, U.S. Pat. No. 6,672,439, issued to Platte, III on Jan. 6, 2004, discloses a paper tote/organizer, U.S. Pat. No. 5,593,086, issued to Ho on Jan. 14, 1997, discloses a document holder with an extensible-retractable bag, U.S. Pat. No. 6,296,112, issued to Pettey on Oct. 2, 2001, discloses a compact disc folder booklet, U.S. Pat. No. 6,419,083, issued to Huang on Jul. 16, 2002, discloses an accordion laser disc protective folder, U.S. Pat. No. 7,699,165, issued to Moeller et al. on Apr. 20, 2010, discloses a multipurpose organizer system and folder with planner and/or writing surface and storage compartments, U.S. Pat. No. D513,279, issued to Hough et al. on Dec. 27, 2005, discloses the ornamental design for a folio filer, U.S. Pat. No. D521,072, issued to Hough et al. on May 16, 2006, discloses the ornamental design for a folio filer, U.S. Pat. No. D529,963, issued to Hough et al. on Oct. 10, 2006, discloses the ornamental design for a folio filer, U.S. Pat. No. 6,431,779, issued to Moor et al. on Aug. 13, 2002, discloses a binder with expandable pockets, U.S. Pat. No. 5,749,666, issued to Yu on May 12, 1998, discloses an expandable file, U.S. Pat. No. D448,799, issued to Moor on Oct. 2, 2001, discloses the ornamental design for a folder, and U.S. Pat. No. 1,794,560, issued to Styll on Mar. 3, 1931, discloses a correspondence folder.

However, none of these binders provide the ability for storage of paper, pencils, scissors, as well as other items for transport between two locations while discretely providing ballistic support materials therein. Typically, these types of binders are utilized by school-age children for organizing and carrying of pencils, pens, paperclips, erasers, as well as materials they create at school or at home and for the transport of such materials between two locations. However, none of the prior art discloses the use of ballistic materials within such folders or binders that are suitable for protecting students from intrusion.

### SUMMARY

Embodiments of the present disclosure relate to folders for carrying and organizing paper and other school materials constructed, in-part, with ballistic materials to provide improved bullet and shrapnel resistance.

Further embodiments of the present disclosure relate to a paper carrying device, comprising at least a front cover and a rear cover and at least three internal compartments for securing and organizing paper and other chattels; wherein each said cover and internal compartment further comprises a ballistic material.

A further embodiment is a folder comprising a front cover and a rear cover and at least one internal panel; each of said front cover, rear cover, and internal panel comprising at a ballistic material; and wherein said internal panel comprises at least one opening for storage and organization of chattels.

A further embodiment is a folder comprising: a generally rectangular front panel having an upper edge; a generally rectangular rear panel spaced from said front panel and having an upper edge; at least one center panel positioned intermediate said front and rear panels, wherein each said panel comprises a left and right side edge; wherein each of said front panel, back panel, and center panel comprise a ballistic material; wherein an accordion material is attached to said left and right side edges, connecting said front, center and rear panels, thereby creating between said central pane and said rear and front panels a compartments, said accordion material adapted to expand along a direction from said center panel toward said rear/front panels, as said compartments are filled; means for hingeably opening and closing said front panel against said center panel; means for selectively retaining said front panel closed against said center panel; further comprising a pair of handles wherein the first of said handles attached to an exterior surface of said front panel proximate said upper edge, and the second of said handles attached to an exterior surface of said rear panel proximate said upper edge, and means for selectively securing said rear panel to said front panel.

A folder comprising an external body having a front and a back cover, a plurality of protective pockets, and multiple accordion folding sheets, comprising: said external body comprising at least one sheet of a ballistic material and configured for opening; plural partitions disposed of in said external body, each partition having a pocket forming body secured on each side thereof, the pocket forming bodies and partitions together forming said protective pockets, each protective pocket having closing means, adapted to receive paper; each said accordion folding sheet being folded in fanned shape so as to have intervals located between its folds, each accordion folding sheet having front and rear fixing ends secured to portions of said external body; and wherein when the external body is opened, all of the pockets are adapted to be displayed, thereby providing convenient access to the materials stored within said pockets.

### BRIEF DESCRIPTION OF THE DRAWINGS

FIG. 1 is a side view of an embodiment of the invention described herein.

FIGS. 2A and 2B are perspective views of embodiments of the invention described herein.

FIG. 3 is a side view of a portion of an embodiment of the invention described herein.

FIGS. 4A and 4B are perspective views of two embodiments of the invention described herein.

FIGS. 5A and 5B are two views of an embodiment utilizing a ring style binder.

FIG. 6 is a top down view of an expanded embodiment of the invention described herein.

FIGS. 7A and 7B are variations on embodiments of the invention described herein.

FIG. 8 is a depiction on an embodiment of the invention described herein.

### DETAILED DESCRIPTION OF PREFERRED EMBODIMENTS

All references cited herein are hereby incorporated by reference in their entirety.

As used herein, the term “about” is intended to encompass a range of values ±10% of the specified value(s). For example, the phrase “about 20” is intended to encompass ±10% of 20, i.e. from 18 to 22, inclusive.

As used herein, the term “school materials” refers to papers, pencils, pens, staplers, erasers, notes, glue, tape, paperclips, straight edges, and other similar materials that are used by school aged children and are commonly transferred from home to school and back.

As used herein, the term “school aged children” refers to kids from ages of about 3 to about 18.

An “accordion material” is a material that can be folded or compressed so as to expand or contract. Such materials can include folded paper materials, elastic materials, and the like.

As used herein, the term “ballistic material” means a material having a NIJ level II or IIA or higher rating as defined by the National Institute of Justice.

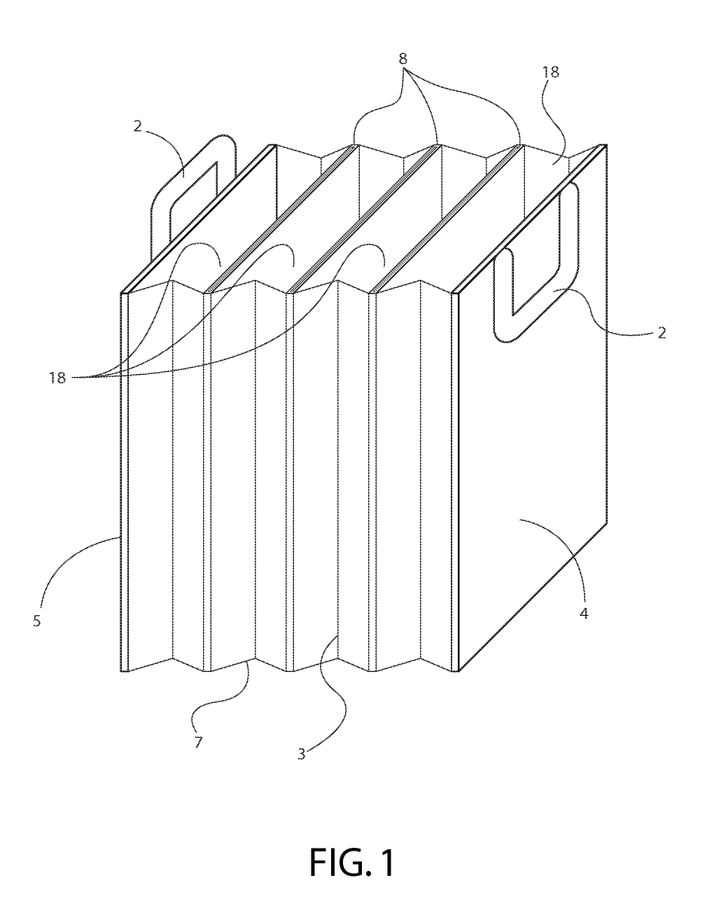

In view of FIG. 1, a folder 1 comprises a pair of handles 2, and front panel 4, a rear panel 5, elastic sides 3 on each side of the folder, and three internal panels 8. The internal panel 8, the front panel 4, and rear panel 5 create pockets 18 which are suitable for holding and/or organizing materials. The folder 1 and the pockets 18 therein are of suitable size to fit normal 8.5″×11″ papers. Indeed, the folder 1 is suitable for carrying either in hand or to be placed in a backpack for containing papers and other school materials such as pencils, erasers, etc. The folder 1 may comprise a single internal panel 8, or multiple internal panels as depicted in FIG. 1, so as to create a plurality of internal pockets 18.

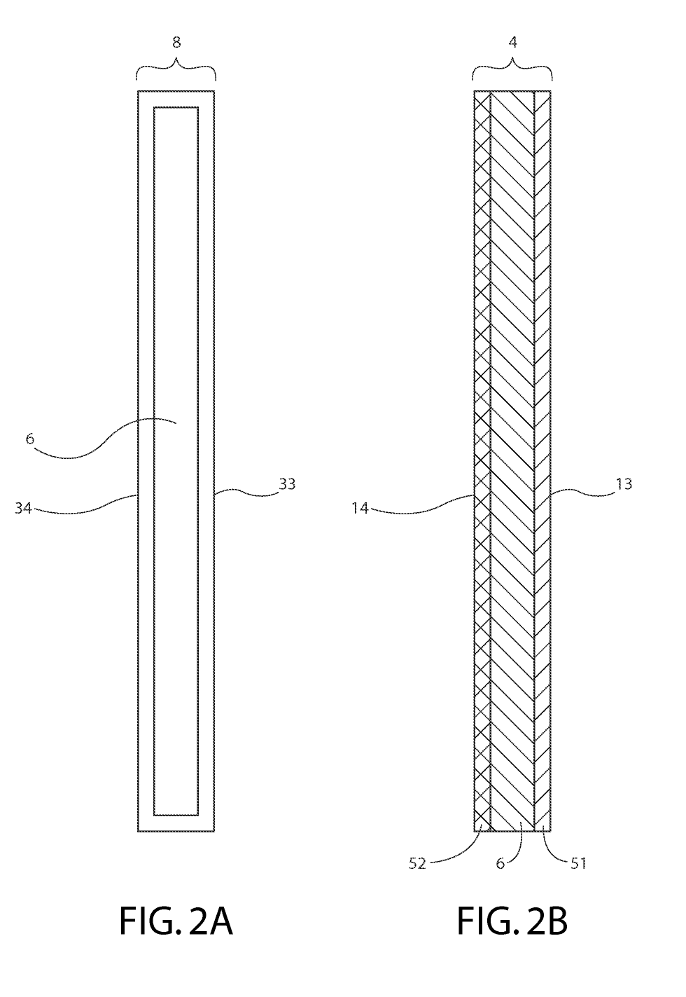

In view of FIG. 2A, a feature of an embodiment of the invention is more particularly disclosed, wherein the ballistic material 6 is disposed of in an internal panel 8. FIG. 2A identifies an internal panel 8, comprising a front panel 33 and a rear panel 34 and sandwiched between is a ballistic material 6. The ballistic material may be glued, stapled, sewn, or otherwise secured between two sheets 33 and 34, that make up the internal panel 8, as depicted in FIG. 2A. Accordingly, the ballistic material 6 is in contact with the materials of the internal panel 8. Accordingly, the use of a single internal panel 8, further comprising a ballistic material, provides that the folder 1 may be suitable to prevent penetration of a fired bullet or other shrapnel. Accordingly, the ballistic material 6 is disposed of within, or on said internal panel 8.

In the same manner that the ballistic material 6 is secured to the internal panel 8, such ballistic material is also suitable secured to other panels in the same manner. It is preferred that at least two panels, i.e. the front and rear panel, or a front and internal panel comprise a ballistic material 6.

In view of FIG. 2B, a further embodiment comprises the addition of at least one polycarbonate plate 51 to the front panel 4. The polycarbonate plate is approximately about 0.1 mm to about 3 mm in thickness, and serves as a soft trauma barrier. Soft trauma occurs when shrapnel or projectiles hit another object or the floor first, thus reducing their velocity. Accordingly, the polycarbonate plate is used in combination with the ballistic material 6, so as to provide a duel system barrier against shrapnel or projectiles. Other embodiments may utilize a material other than polycarbonate for the soft trauma barrier, as these materials are known of one of skill in the art. In preferred embodiments the polycarbonate plate 51 is included in the front panel 4 the rear panel, and/or in at least one internal panel 8.

FIG. 2B further depicts a sheet of GA 20 foam 52 in the front panel 4. The foam is about 0.1 mm to about 3 mm in thickness. The foam provides support for the ballistic material 6 as well as providing protection for the ballistic material 6 and the components within the folder 1. In a particularly preferred embodiment, a sheet of GA 20 foam 52 is situated within the front panel 4, the back panel 5 and within at least one internal panel 8. Other suitable thicknesses of foam are suitable, from about 0.1 to about 10 mm. It may be appropriate to use a thicker foam on a front panel 4 or back panel 5 than in an internal panel 8.

In other embodiments, foam sheets, such as GA 20 are utilized in each internal panel 8. Other suitable foam materials may be exchanged for the GA 20 material, wherein they provide similar properties, as is known to one of skill in the art.

In some embodiments, it is suitable that the internal panel 8 is wholly fabricated from the ballistic material. Regardless of the material of the internal panel 8, additional features, such as a pocket, may be thereafter secured to said internal panel 8.

The ballistic material 6 comprises any number of now known or materials to be developed that have a NIJ rating of II or IIA or higher. Preferably, the ballistic material 6 is a lightweight material capable of being secured to another material, either by an adhesive or stitching, or is suitable for being secured between two other materials. A folder comprises at least one sheet of ballistic material 6, the location of this sheet can be either the front cover 4, the back cover 5, or an internal panel. It may be preferable to provide several sheets of ballistic material either together, or spaced apart, so as to ensure lightweight but safe materials for use by school aged children.

In a preferred embodiment, at least three total sheets of ballistic material 6 are utilized within a folder 1; one secured to the front cover 4, one to the back cover 5, and at least one utilized within or secured to an internal panel 8. The ballistic materials 6 used for each of the front, back and internal panels may be of the same or different rating. In particular, the goal is to provide for a folder 1 that continues to be lightweight and user friendly for school age children, while still providing enhanced ballistic protection.

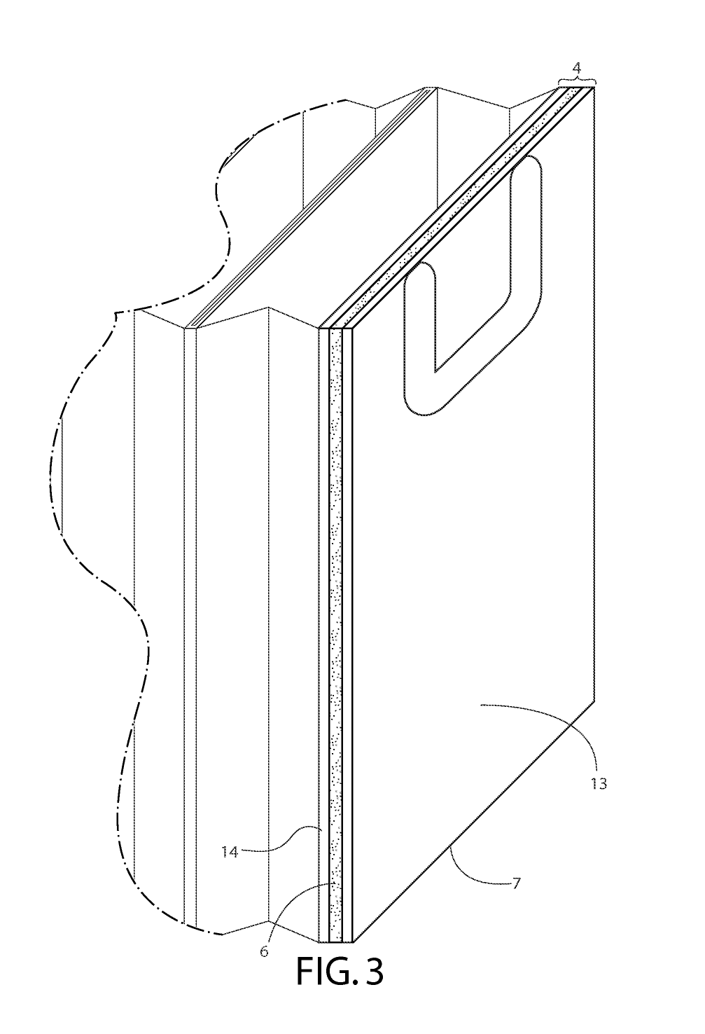

In view of FIG. 3, a ballistic material 6 is incorporated into the front panel 4. The front panel 4 therefore comprises an outer front panel 13, the ballistic material 6, than an inner front panel 14. This provides that the ballistic material 6 is sandwiched between two panels. Furthermore, such as depicted in FIG. 2b, other materials may also be combined to make up a panel, whether front, rear, or internal. Accordingly, the ballistic material is protected from wear and also disguises that the folder 1 comprises such ballistic material. Accordingly, the aesthetics of the outer front panel 13 may comprise any number of plastic, paper, textile, leather, or other natural or artificial materials. The inner front panel 14 may comprise the same or a different material.

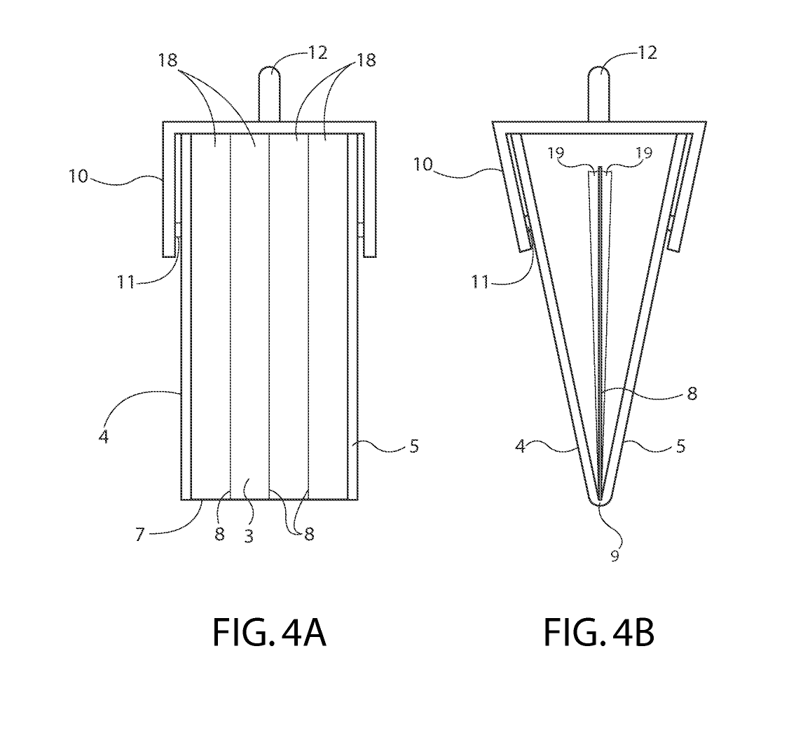

In view of FIGS. 4A and 4B another embodiment of the invention comprises a flap 10 and a clasp 11 that reaches from the rear panel 5 to the front panel 4 to secure the folder 1. FIG. 4A comprises multiple internal panels 8 and has a flat shaped bottom. The panels provide for the creation of pockets 18 between the various panels. The flat bottom 7, has the front, rear, and internal panels connecting to a bottom material 7 at different points. The bottom material 7 may comprise a pliable or flexible material so that it can collapse. Regardless, the bottom material should allow for the folder 1 to be expanded so as to access materials within the folder.

In FIG. 4B, the folder 1 comprises a pointed bottom 9. Typically, the bottom will come to either a point, where the front, rear, and internal panels join together at about the same point. The construction allows the folder 1 to open so that the front panel 4 and rear panel 5 are at about a 180 degree angle, and thus the folder 1 can lay flat on a surface. Furthermore, the internal panel 8 comprises two pockets 19 that are secured to the panel. These pockets may be made of any suitable material for storage of any number of materials. It is advantageous to provide at least one of the pockets with a clear or non-opaque material so that the items inside the pocket 19 can be seen. These pockets 19 can be open, so that paper may slide in and out of the pocket, or may comprise a clasp, or other closing means, such as snaps, hook and loop, zipper, magnetism, or other securing or closing mechanisms known to one of skill in the art.

Therefore, a preferred embodiment comprises a folder comprising: a generally rectangular front panel, 4 having an upper edge; a generally rectangular rear panel 5 spaced from said front panel and having an upper edge; at least one center panel 8 positioned intermediate said front 4 and rear panels 5, wherein each said panel comprises a left and right side edge; wherein each of said front panel 4, back panel 5, and center panel 8 comprise a ballistic material 6. Attached to the left and right side edges and connecting the front, center and rear panels is an according material, thereby creating a compartment between said central pane and said rear and front panels. The accordion material is adapted to expand along a direction from said center panel toward said rear/front panels, as said compartments are filled. The panels are secured together at a base e.g. 9 for hingeably opening and closing said front panel 4 against said center panel 8. Furthermore a latching means 11 for selectively retaining said front panel 4 closed against said rear panel 5. It is preferred that at least one handle 12 is attached to an exterior surface of said front panel proximate said upper edge.

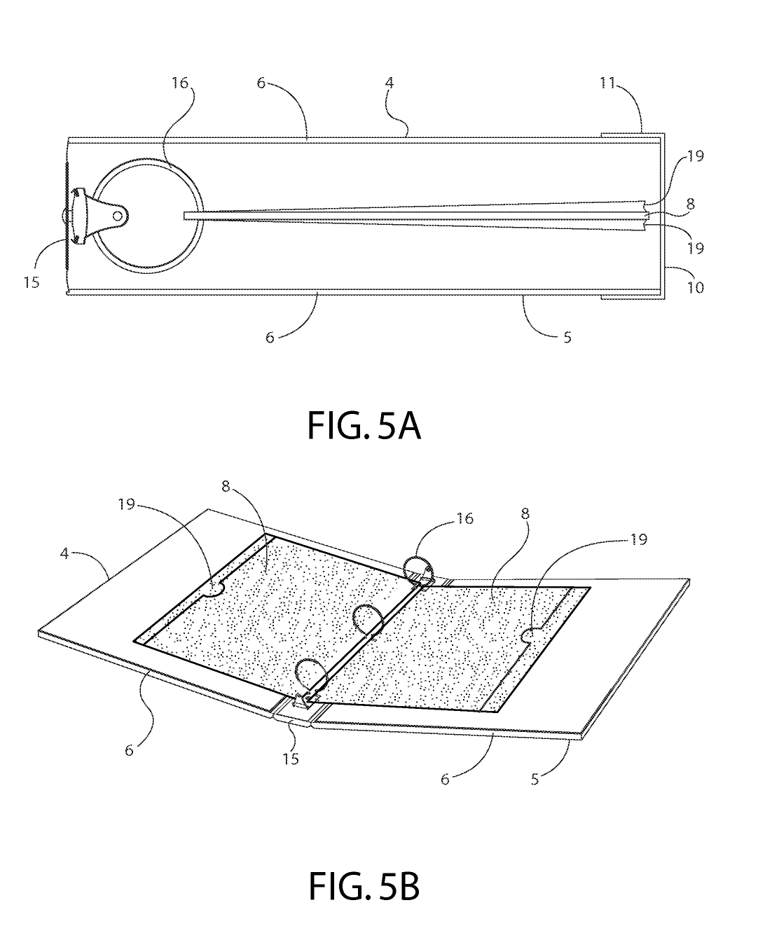

In view of FIGS. 5A and 5B a ringed binder may be utilized. Accordingly, there is still a front panel 4 and a rear panel 5, but also comprising a spine 15, wherein the rings 16 for the binder are attached. The rings 16 may be selectively open to allow for thee-hole punched papers to be secured within the rings. Internal panels 8 may be selectively attached to the rings 16. The internal panel 8 further comprises a pocket 19. Each internal panel 8 may comprise zero, one, two, or more pockets 19. For example, one side may comprise a single large pocket for storing papers, and the reverse side of the internal panel 8 may comprise 2 small pockets for storage of money, pens, paperclips, erasers, pencils, etc., as would be needed by a school aged child. In some embodiments, a clasping mechanism 11 and a flap 10 may be secured to said binder to allow for the front and rear panels to be secured together. Other embodiments may eliminate this mechanism.

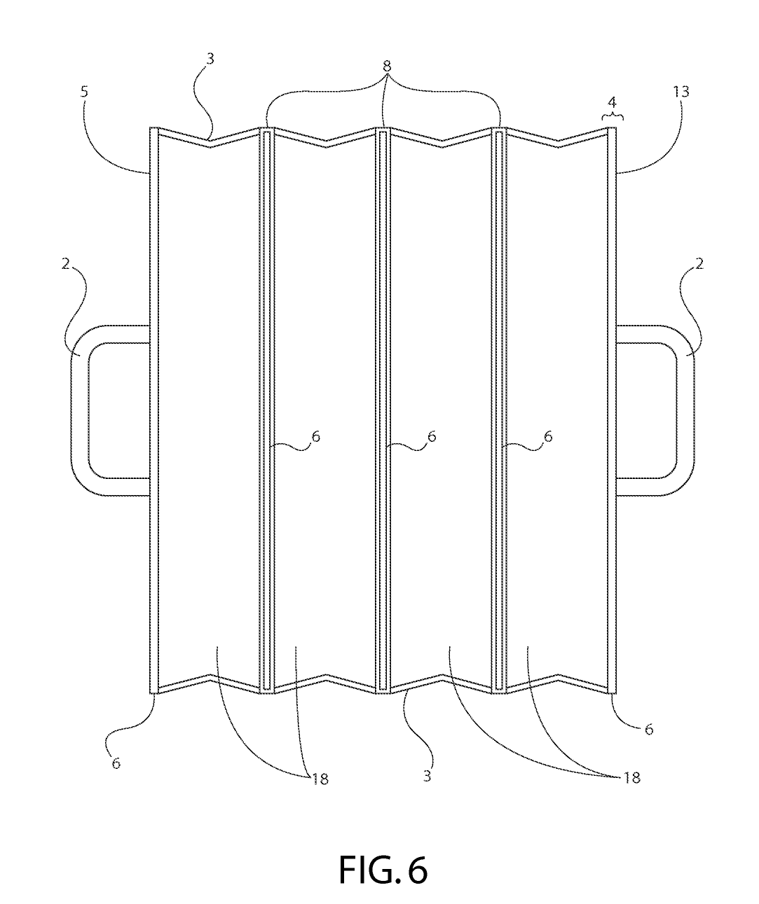

In view of FIG. 6, a binder 1 comprises three internal panels 8, a pair of handles 2, a front panel 4, and a rear panel 5. In this embodiment, the outer front panel 13 is a material different than the ballistic material 6, which is directly secured to the outer front panel 13. Accordingly, the ballistic material 6 is only covered on the outer side of the front panel 4. The rear panel 5 comprises the same construction. The internal panels 8 are solely made of a ballistic material. This provides that in some embodiments, it is possible to reduce weight of the product, by making the internal panels 8 solely constructed of a ballistic material.

In other embodiments, it is important to protect the ballistic material with at least a thin sheet of some other non-ballistic material. Accordingly, the material may be glued or sewn to the ballistic material as known to one of ordinary skill in the art. Therefore, in some embodiments, the construction of the folder may comprise any combination of the elements described herein, so as to provide for a folder comprising a ballistic material, suitable of providing for NIJ level II, IIA, or higher protection, and being of such size and weight to be easily carried by a school age child.

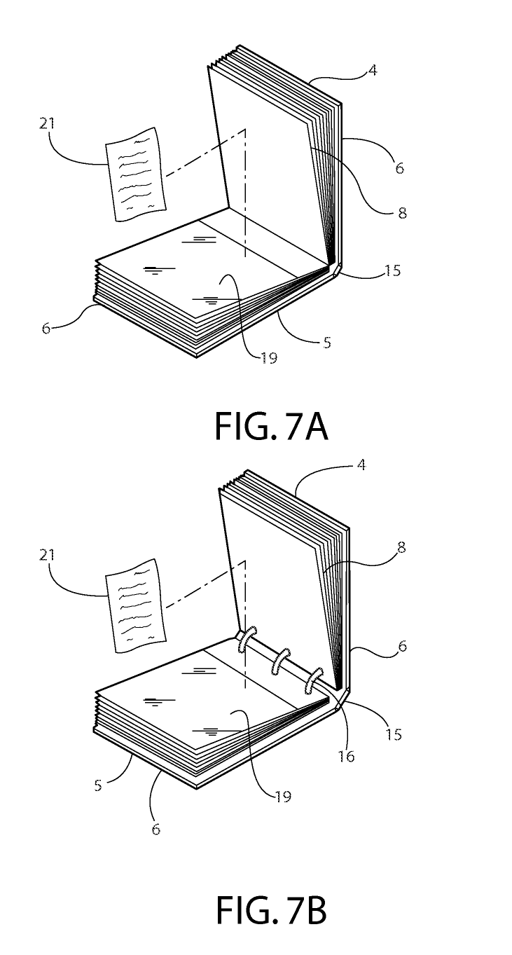

In view of FIG. 7A, a folder comprising a front panel 4 and a rear panel 5, each comprising a ballistic material 6. The embodiment further comprises internal panels 8 that contain folders 19. As shown, a piece of paper 21, standard 8.5″×11″ is suitable for being stored within one of the plurality of internal panels 8. The Internal pockets are secured together at the spine 15.

In view of FIG. 7B, a folder 1 comprising a front panel 4, a back panel 5, a set of rings 16 to hold the internal panels 8. Each of the front pane 4 and back pane 5 comprises a ballistic material 6. Like FIG. 7A, the internal panels 8 comprising pockets 19 which are suitable for holding paper materials 21 in said pockets 19.

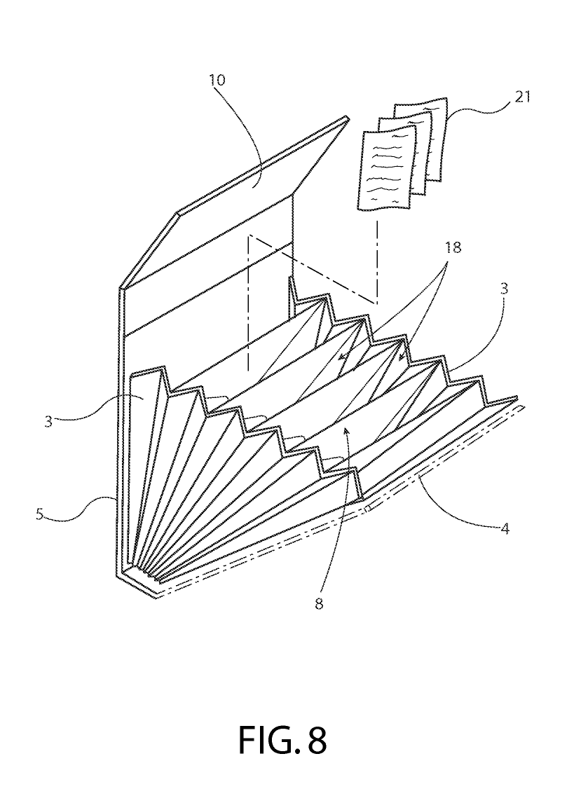

In view of FIG. 8 the folder 1 comprises a front panel 4 a back panel 5 and an accordion side panel 3 disposed of on each the left and right side of the folder. Disposed between the front panel 4 and back panel 5 are internal panels 8. Each of the internal panels 8 are attached to the side panels 3 and accordingly, create compartments 18 between the internal panels 8 as well as between said internal panels 8 and the front panel 4 and the back panel 5.

It is considered that the folder may be carried in hand or would be suitable for placement in a bag, backpack, or other carrying device. It is also suitable for attaching a shoulder strap or a longer carrying strap. A further embodiment may utilize a pair or group of wheels and a telescoping handle in further embodiments, so that the folder 1 may be rolled instead of carried.

Accordingly, preferred embodiments of the folder include a folder system having a spine or bottom element, a front cover and a rear cover and at least one internal panel 8, wherein the internal panel 8 is secured to the spine or bottom element thereby holding the front cover, rear cover, and internal panel about parallel to one another. Secured to the sides of the folder is a movable material, that allows the folder to open and move, but creates between the internal panel 8 and the front cover and rear cover, pockets for placement of school materials. In such preferred embodiment, a ballistic material is included within the front cover, the rear cover, and the internal panel.

In a further preferred embodiment, the internal panels are themselves folders, and are secured to a spine. Further connected to the spine are the front cover and rear cover. Because the internal panels are folders, a side paneling is not required to create a folder. Instead, the school materials are placed directly into a folder, much like a typical 3-ring binder has open sides. However, disposed of on or within the front cover, the rear cover, and at least one internal panel is a ballistic material.

In a preferred embodiment, a folder includes an external body made of a front and a back cover, a plurality of protective pockets, and two accordion folding sheets that attach at the sides of the front and back covers. The external body is configured to expand to expose the internal pockets. Indeed, there are preferably a plurality of partitions disposed of in said external body, each partition having a pocket forming body secured on each side thereof, the pocket forming bodies and partitions together forming said protective pockets, each protective pocket having closing means, adapted to receive paper. It is preferred that each said accordion folding sheet being folded in fanned shape so as to have intervals located between its folds, each accordion folding sheet having front and rear fixing ends secured to portions of said external body. Finally, when the shell body is opened, all of the pockets are adapted to be displayed, thereby providing convenient access to the materials stored within said pockets.

In a further preferred embodiment, a folder comprises a front cover, a rear cover, at least two internal panels, and a polycarbonate plate.

In a further preferred embodiment a folder comprises a front cover, a rear cover, at least two internal panels, a polycarbonate plate, and GA foam.

The materials, methods, and figures presented herein are intended to be illustrative, and not to be construed as limiting the scope or content of the invention. Unless otherwise defined, all technical and scientific terms are intended to have their art-recognized meanings.

What is claimed is:

1. A folder for carrying school materials comprising a spine, a front cover, a rear cover, and at least one internal panel; wherein said front cover, rear cover, and at least one internal panel are each attached to said spine and allowing each of the front cover, rear cover, and internal panel to be held about parallel to one another; and wherein each of said front cover, rear cover, and internal panel comprising at least one ballistic material.

2. The folder of claim 1 wherein said internal panel comprises at least one opening for storage and organization of chattels or other school materials.

3. The folder of claim 1 wherein said ballistic material meets the standards for a NIJ level II or IIA or higher rating.

4. The folder of claim 1 further comprising a first polycarbonate plate disposed of in the front cover and second polycarbonate plate disposed of in the rear cover.

5. The folder of claim 1 further comprising a foam sheet disposed of in said front cover and said rear cover.

6. The folder of claim 1 further comprising at least two wheels and a telescoping handle; wherein said wheels are secured to said spine, and said telescoping handle is secured to said rear cover.

7. The folder of claim 1 further comprising a pair of handles, one secured to each the front and rear cover.

8. The folder of claim 1 further comprising a shoulder strap.

9. The folder of claim one wherein said internal panel comprises a ballistic material and a two sheets of a second material that sandwich the ballistic material, wherein the ballistic material is secured between said two sheets by materials consisting of glue, staples, thread, or combinations thereof.

10. The folder of claim 1 comprising at least three internal panels; wherein said front cover, rear cover, and at least three internal panels are arranged parallel to one another, but secured in different positions along said spine, such that said covers and internal panels create spaces between the cover and panel or between each panel; and wherein each said cover and internal compartment further comprises a ballistic material.

11. A folder comprising:
a. a generally rectangular front panel having an upper edge;
b. a generally rectangular rear panel spaced from said front panel and having an upper edge;
c. at least one center panel positioned intermediate said front and rear panels, wherein each said panel comprises a left and right side edge;
d. wherein each of said front panel, back panel, and center panel comprise a ballistic material;
e. wherein an accordion material is attached to said left and right side edges, connecting said front, center and rear panels, thereby creating between said central pane and said rear and front panels a compartments, said accordion material adapted to expand along a direction from said center panel toward said rear/front panels, as said compartments are filled;
f. means for hingeably opening and closing said front panel against said center panel;
g. means for selectively retaining said front panel closed against said center panel; and
h. means for selectively securing said rear panel to said front panel.

12. The folder of claim 11 further comprising a pair of handles wherein the first of said handles attached to an exterior surface of said front panel proximate said upper edge, and the second of said handles attached to an exterior surface of said rear panel proximate said upper edge.

13. The folder of claim 11 wherein said ballistic material meets the standards for a NIJ level II or IIA or higher rating.

14. The folder of claim 11 further comprising a first polycarbonate plate disposed of in the front panel and second polycarbonate plate disposed of in the rear panel.

15. The folder of claim 11 further comprising a foam sheet disposed of in at least one of said front panel, said rear panel, or an internal panel.

16. A folder comprising an external body having a front and a back cover, a plurality of protective pockets, and two accordion folding sheets, wherein:
a. said external body comprises at least one sheet of a ballistic material and configured for opening;
b. a plurality of partitions disposed of in said external body, each partition having a pocket forming body secured on each side thereof, the pocket forming bodies and partitions together forming a protective pocket, each protective pocket having closing means, adapted to receive paper;
c. each said accordion folding sheet being folded in fanned shape so as to have intervals located between its folds, each accordion sheet having front and rear fixing ends secured to portions of said external body; and
d. wherein when the shell body is opened, all of the pockets are adapted to be displayed, thereby providing convenient access to the materials stored within said pockets.

17. The folder of claim 16 wherein at least one of said pocket form body comprises a non-opaque material.

18. The folder of claim 16 wherein said ballistic material meets the standards for a NIJ level II or IIA or higher rating.

19. The folder of claim 16 further comprising a first polycarbonate plate disposed of in the front cover and second polycarbonate plate disposed of in the back cover.

20. The folder of claim 16 further comprising a foam sheet disposed of in at least one of said front cover, said rear cover, or a partition.
